(19) United States
(12) Patent Application Publication
(10) Pub. No.: US 2015/0364084 A1
(43) Pub. Date: Dec. 17, 2015

(54) PIXEL DRIVING CIRCUIT AND ORGANIC LIGHT EMITTING DISPLAY DEVICE

(71) Applicants: Shanghai Tianma AM-OLED Co., Ltd., Shanghai (CN); TIANMA MICRO-ELECTRONICS CO., LTD., Shenzhen (CN)

(72) Inventors: Hanyu GU, Shanghai (CN); Dong Qian, Shanghai (CN); Tong Zhang, Shanghai (CN)

(21) Appl. No.: 14/515,532

(22) Filed: Oct. 16, 2014

(30) Foreign Application Priority Data
Jun. 13, 2014 (CN) 201410265086.0

(51) Int. Cl. G09G 3/32

(52) U.S. Cl. CPC G09G 3/3233; G09G 2320/045; G09G 2320/0233; G09G 2300/0814; G09G 2300/0819

(57) ABSTRACT

Embodiments of the invention provide a pixel driving circuit and a display device, and the pixel driving circuit includes a drive transistor and an organic light emitting diode, where a cathode of the organic light emitting diode receives a first power supply signal, and an anode of the organic light emitting diode is connected with a gate electrode of the drive transistor; the first power supply signal is loaded to the gate electrode of the drive transistor through the cathode and the anode of the organic light emitting diode to reset a signal at the gate electrode of the drive transistor during an operating period of the pixel driving circuit; and the first power supply signal is a low-level signal.

### CROSS-REFERENCES TO RELATED APPLICATIONS

The present application claims priority of Chinese patent application No. 201410265086.0 filed on Jun. 13, 2014, the content of which is incorporated herein by reference in its entirety.

### BACKGROUND OF THE INVENTION

Active Matrix Organic Light Emitting Diode (AMOLED) display has been widely used due to its wide angle of view, good color contrast effect, high response speed, low cost and other advantages. However a drift in the threshold voltage may arise as a result of non-uniformity and instability of a Thin Film Transistor (TFT) back panel in the process flow.

There are many existing techniques associated with AMOLED and TFT systems. Unfortunately, they have been inadequate, and new and improved systems and methods thereof are therefore desired.

### SUMMARY OF THE INVENTION

An embodiment of the invention provides a pixel driving circuit including a drive transistor and an organic light emitting diode, where a cathode of the organic light emitting diode receives a first power supply signal, and an anode of the organic light emitting diode is connected with a gate electrode of the drive transistor; the first power supply signal is loaded to the gate electrode of the drive transistor through the cathode and the anode of the organic light emitting diode to reset a signal at the gate electrode of the drive transistor during an operating period of the pixel driving circuit; and the first power supply signal is a low-level signal. There are other embodiments as well.

### BRIEF DESCRIPTION OF THE DRAWINGS

FIG. 1 is a schematic diagram of a pixel driving circuit according to a first embodiment of the invention;

FIG. 2 is an operation timing diagram of the pixel driving circuit according to the first embodiment of the invention;

FIG. 3 is another operation timing diagram of the pixel driving circuit according to the first embodiment of the invention;

FIG. 4 is a schematic diagram of a pixel driving circuit according to a second embodiment of the invention;

FIG. 5 is an operation timing diagram of the pixel driving circuit according to the second embodiment of the invention; and

FIG. 6 is another operation timing diagram of the pixel driving circuit according to the second embodiment of the invention.

### DETAILED DESCRIPTION OF THE EMBODIMENTS

The present invention relates to the field of display technologies and particularly to a pixel driving circuit and an organic light emitting display device.

As mentioned above, existing display systems are inadequate in various ways. In the existing organic light emitting diode display device, drifts in threshold voltages of drive transistors in respective pixel units may arise as a result of slight differences in parameters of the drive transistors, so drive currents of the different pixel units may be different when the same image data signal is received, thus degrading the display quality. On the other hand, when the continuous display is performed by the organic light emitting diode display device, a low-level signal may be loaded as a reset signal to a gate electrode of a drive transistor in the same pixel unit to thereby eliminate the residue of the previous frame of image signal. However in order to load the reset signal, there is a need to introduce an additional switch transistor and the reset signal, thus increasing the complexity of designing and driving the pixel driving circuit.

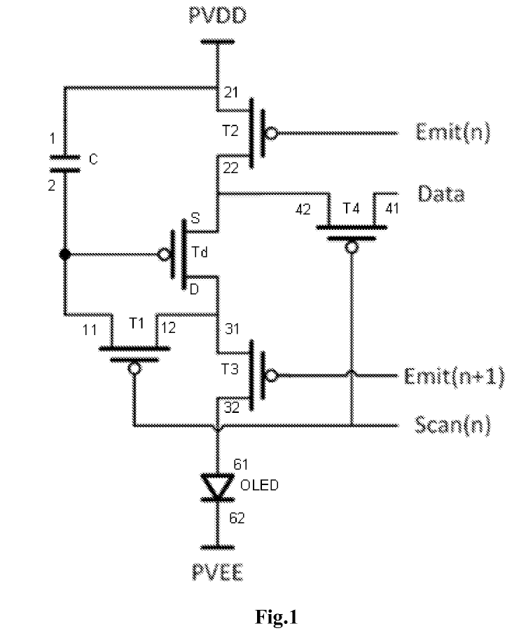

Referring to FIG. 1, there is illustrated a schematic diagram of a pixel driving circuit according to a first embodiment of the invention, which includes a drive transistor Td and an organic light emitting diode OLED, where a cathode 62 of the organic light emitting diode OLED receives a first power supply signal PVEE. An anode 61 of the organic light emitting diode OLED is connected with a gate electrode of the drive transistor Td. The first power supply signal PVEE is loaded to the gate electrode of the drive transistor Td through the organic light emitting diode OLED to reset a signal at the gate electrode of the drive transistor Td during an operating period of the pixel driving circuit. The first power supply signal PVEE is a low-level signal.

In the first embodiment of the invention, the low-level signal of the first power supply signal PVEE is used to reset the signal at the gate electrode of the drive transistor Td to thereby eliminate the influence from a previous frame of displayed image, and the first power supply signal PVEE providing the organic light emitting diode OLED with the low-level signal is used instead of a separate reset signal.

In the first embodiment of the invention, the anode 61 of the organic light emitting diode OLED is connected with the gate electrode of the drive transistor Td through a third switch transistor T3 and a first switch transistor T1. Specifically, as illustrated in FIG. 1, the pixel driving circuit includes the first switch transistor T1, a second switch transistor T2, the third switch transistor T3, a fourth switch transistor T4, the drive transistor Td, a storage capacitor C and the organic light emitting diode OLED.

A first pole 11 of the first switch transistor T1 is connected respectively with the gate electrode of the drive transistor Td and a second pole plate 2 of the storage capacitor C. A second pole 12 of the first switch transistor T1 is connected respectively with a drain electrode D of the drive transistor Td and a first pole 31 of the third switch transistor T3. A gate electrode of the first switch transistor T1 receives a scan signal Scan(n).

A first pole 21 of the second switch transistor T2 is connected respectively with a second power supply signal PVDD and a first pole plate 1 of the storage capacitor C. A second pole 22 of the second switch transistor T2 is connected respectively with a source electrode S of the drive transistor Td and a second pole 42 of the fourth switch transistor T4. A gate electrode of the second switch transistor T2 receives a first light emission signal Emit(n).

The first pole 31 of the third switch transistor T3 is connected respectively with the drain electrode D of the drive transistor Td and the second pole 12 of the first switch transistor T1. A second pole 32 of the third switch transistor T3 is connected with the anode 61 of the organic light emitting diode OLED. A gate electrode of the third switch transistor T3 receives a second light emission signal Emit(n+1).

A first pole 41 of the fourth switch transistor T4 receives an image data signal Data, the second pole 42 of the fourth switch transistor T4 is connected respectively with the second pole 22 of the second switch transistor T2 and the source electrode S of the drive transistor Td, and a gate electrode of the fourth switch transistor T4 receives the scan signal Scan(n).

The source electrode S of the drive transistor Td is connected respectively with the second pole 22 of the second switch transistor T2 and the second pole 42 of the fourth switch transistor T4. The drain electrode D of the drive transistor Td is connected respectively with the second pole 12 of the first switch transistor T1 and the first pole 31 of the third switch transistor T3. The gate electrode of the drive transistor Td is connected respectively with the first pole 11 of the first switch transistor Ti and the second pole plate 2 of the storage capacitor C.

The first pole plate 1 of the storage capacitor C is connected with the first pole 21 of the second switch transistor T2, the first pole plate 1 of the storage capacitor C further receives the second power supply signal PVDD, and the second pole plate 2 of the storage capacitor C is connected respectively with the first pole 11 of the first switch transistor T1 and the gate electrode of the drive transistor Td.

The anode 61 of the organic light emitting diode OLED is connected with the second pole 32 of the third switch transistor T3, and the cathode 62 of the organic light emitting diode OLED receives the first power supply signal PVEE.

In order to eliminate the influence of the previous frame of image data signal on the display of the current frame in the pixel circuit, the low-level signal of the first power supply signal PVEE is transmitted to the gate electrode of the drive transistor Td through the organic light emitting diode OLED, the third switch transistor T3 and the first switch transistor T1 to reset the signal at the gate electrode of the drive transistor Td in the pixel driving circuit according to the first embodiment of the invention. Specifically, when each frame is displayed, the gate electrode of the drive transistor Td is charged by the image data signal Data, and when the gate electrode voltage Vg of the drive transistor Td is increased to the sum of the source electrode voltage Vs thereof and the threshold voltage Vth thereof, the drive transistor Td is turned off, and at this time the gate electrode voltage Vg of the drive transistor Td is (Vdata+Vth). If the gate electrode voltage Vg of the drive transistor Td is not lowered to a low potential (i.e., is not reset) before a next frame of image data signal Data is written, then the next frame of image data signal Data cannot be written because the drive transistor Td is turned off. The drive transistor Td can be turned on by resetting the signal at the gate electrode thereof to thereby ensure the next frame of image data signal Data to be written.

The signal at the gate electrode of the drive transistor Td is reset before the current frame of image data signal Data is input, namely, in an initialization phase I. During the initialization phase I, the second light emission signal Emit(n+1) and the scan signal Scan(n) provide turn-on signals, and both the third switch transistor T3 and the first switch transistor T1 are turned on, so that the first power supply signal PVEE can be transmitted to the gate electrode of the drive transistor Td through the third switch transistor T3 and the first switch transistor T1 to reset the drive transistor Td.

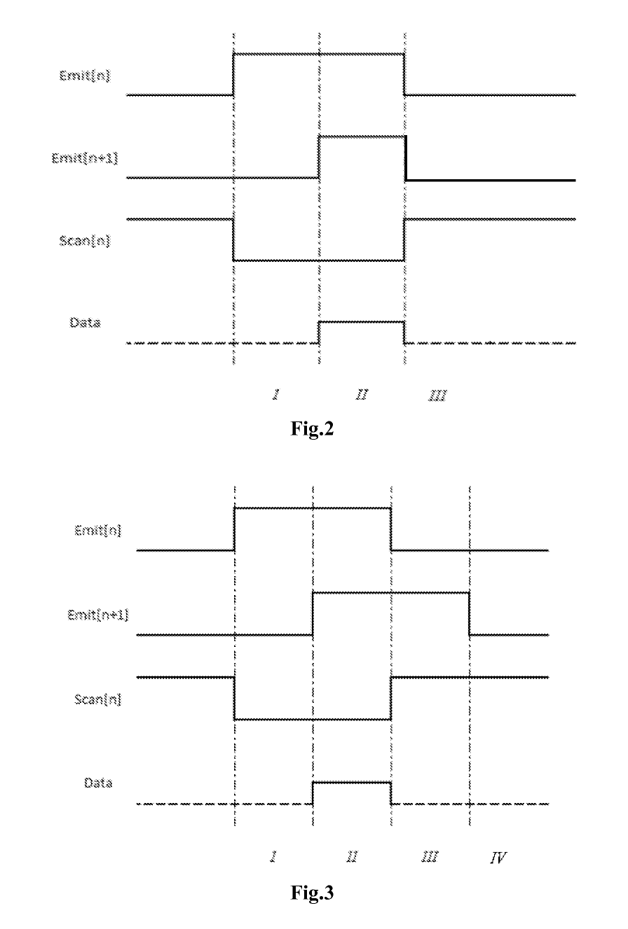

The operating period of the pixel driving circuit further includes a signal load phase II and a light emission phase III subsequent to the initialization phase I. Referring to FIG. 2, there is illustrated an operation timing diagram of the pixel driving circuit according to the first embodiment of the invention.

During the initialization phase I, the first light emission signal Emit(n) provides a turn-off signal. The second light emission signal Emit(n+1) provides a turn-on signal. The scan signal Scan(n) provides a turn-on signal. Thus the first switch transistor T1 and the third switch transistor T3 are turned on. The first power supply signal PVEE is transmitted to the gate electrode of the drive transistor Td. The second switch transistor T2 is turned off, so the second power supply signal PVDD can not transmit a signal to the pixel driving circuit. Although the fourth switch transistor T4 is turned on, the image data signal Data has not transmitted a signal to the pixel driving circuit. The pixel driving circuit performs the reset operation of the drive transistor Td so that the potential of the gate electrode of the drive transistor Td is the low potential of the first power supply signal PVEE.

In the signal load phase II, the first light emission signal Emit(n) provides a turn-off signal. The second light emission signal Emit(n+1) provides a turn-off signal. The scan signal Scan(n) provides a turn-on signal. The image data signal Data transmits a display signal. The second switch transistor T2 and the third switch transistor T3 are turned off, and the first switch transistor T1 and the fourth switch transistor T4 are turned on. The drive transistor Td is also turned on because the gate electrode of the drive transistor Td is still at the low potential of the first power supply signal PVEE when the signal load phase II just starts. The image data signal Data is transmitted to the source electrode S of the drive transistor Td through the fourth switch transistor T4, that is, the source electrode voltage Vs of the drive transistor Td is Vdata.

The first switch transistor T1, the fourth switch transistor T4 and the drive transistor Td are all turned on, that is, the gate electrode and the drain electrode D of the drive transistor Td are connected. The gate electrode of the drive transistor Td is charged by the image data signal Data, and when the gate electrode voltage Vg of the drive transistor Td is increased to the sum of the source electrode voltage Vs thereof and the threshold voltage Vth thereof, the drive transistor Td is turned off, and at this time the gate electrode voltage Vg of the drive transistor Td is:

Vg=Vs+Vth=Vdata+Vth (1)

At this time the voltage of the second pole plate 2 of the storage capacitor C is also (Vdata+Vth), that is, the gate electrode voltage of the drive transistor Td is stored in the second pole plate 2 of the storage capacitor C.

Next in the light emission phase III, the first light emission signal Emit(n) provides a turn-on signal, the second light emission signal Emit(n+1) provides a turn-on signal, the scan signal Scan(n) provides a turn-off signal, and the image data signal Data does not transmit the display signal any more. The first switch transistor T1 is turned off, that is, the gate electrode and the drain electrode D of the drive transistor Td are disconnected, and the third switch transistor T3 is turned on, that is, the drain electrode D of the drive transistor Td is connected with the anode of the organic light emitting diode OLED, so that the organic light emitting diode OLED can be driven by the drain electrode current of the drive transistor Td to emit light. Also since the second switch transistor T2 is turned on, the source electrode voltage Vs of the drive transistor Td is the high voltage Vdd of the second power supply signal PVDD in the light emission phase III, and at this time the drain electrode current I of the drive transistor Td is:

$$I = \frac{1}{2} {k ( Vg - Vs - Vth )}^{2} = \frac{1}{2} {k ( Vdata - Vdd )}^{2} \qquad ( 2 )$$

Where K is a constant. As shown in Equation (2), the drain electrode current I of the drive transistor Td is independent of the threshold voltage Vth of the drive transistor Td, so the non-uniformity of display due to different threshold voltages of multiple drive transistors can be eliminated to thereby achieve a better display effect in the pixel driving circuit according to the first embodiment of the invention.

In the pixel driving circuit according to the first embodiment of the invention, the signal at the gate electrode of the drive transistor Td is reset by the first power supply signal PVEE prior to the signal load phase to thereby ensure the current frame of image data signal Data to be written smoothly, and also the reset signal is provided by the first power supply signal PVEE which originally provides the cathode signal to the organic light emitting diode OLED, instead of a separate reset signal, to thereby simplify the circuit structure and facilitate the miniaturization of the pixel driving circuit. Moreover the non-uniformity of display due to different threshold voltages of multiple drive transistors can be eliminated to thereby achieve the better display effect in the pixel driving circuit according to the first embodiment of the invention.

Preferably, in two adjacent pixel driving circuits, the second light emission signal Emit(n+1) of the previous pixel driving circuit is the same signal as the first light emission signal Emit(n) of the next pixel driving circuit. Referring to FIG. 3, there is illustrated another operation timing diagram of the pixel driving circuit according to the first embodiment of the invention, which includes an initialization phase I, a signal load phase II, a wait phase III and a light emission phase IV in that order, where the difference from the operation timing diagram illustrated in FIG. 2 lies in that there is further the wait phase between the signal load phase and the light emission phase. In the another operation timing, in two adjacent pixel driving circuits, the second light emission signal Emit(n+1) of the previous pixel driving circuit is the same signal as the first light emission signal Emit(n) of the next pixel driving circuit.

In the operation timing of the pixel driving circuit according to the first embodiment of the invention, as can be appreciated, in an array of pixel driving circuits, the first light emission signal Emit(n) of each pixel driving circuit is a light emission signal at a high level provided sequentially by the same clock signal, and the second light emission signal Emit(n+1) of each pixel driving circuit is also a light emission signal at a high level provided sequentially by the same clock signal, so two signal source electrodes of the light emission signals are required to drive one pixel driving circuit for normal operation, and the high level of the second light emission signal Emit(n+1) is triggered later than the high level of the first light emission signal Emit(n) by the initialization phase.

In two adjacent pixel driving circuits, when the second light emission signal Emit(n+1) in the previous pixel driving circuit starts to provides the high level in the signal load phase II, the first light emission signal Emit(n) in the next pixel driving circuit starts to provides the high level in the initialization phase I. In the two adjacent pixel driving circuits, the time when the second light emission signal Emit(n+1) in the previous pixel driving circuit provides the high level is the same as the time when the first light emission signal Emit(n) in the next pixel driving circuit provides the high level, so the two signals can be used as a single signal, and thus only one light emission signal source electrode is required throughout the arrays of pixel driving circuits to drive the pixel driving circuits for normal operation.

Further referring to FIG. 3, since the first light emission signal Emit(n) and the second light emission signal Emit(n+1) are light emission signals at the high level provided sequentially by the same clock signal, the pulse widths, i.e., the durations of the high level, of the two light emission signals are also the same. In the signal load phase II, the second light emission signal Emit(n+1) provides the high level to control the third switch transistor T3 to be turned off so as to ensure the image data signal Data to be written; and in the wait phase III, the second light emission signal Emit(n+1) is maintained at the high level. In the wait phase III, all of the first light emission signal Emit(n), the scan signal Scan(n) and the image data signal Data are the same as those in the light emission phase IV.

The same operation effect as the operation timing illustrated in FIG. 2 can also be achieved by using the another operation timing of the pixel driving circuit according to the first embodiment of the invention, but the second light emission signal Emit(n+1) in the previous pixel driving circuit is the same signal as the first light emission signal Emit(n) of the next pixel driving circuit to thereby dispense with one signal source electrode so as to further simplify the method of driving the pixel driving circuits.

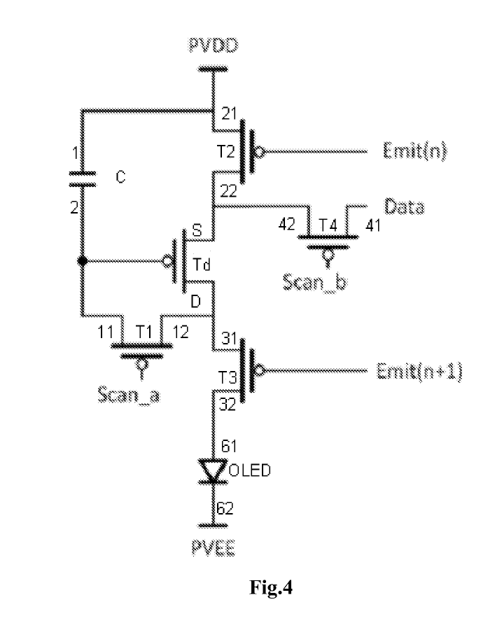

Referring to FIG. 4, there is illustrated a schematic diagram of a pixel driving circuit according to a second embodiment of the invention, which includes a drive transistor Td and an organic light emitting diode OLED, where a cathode 62 of the organic light emitting diode OLED receives a first power supply signal PVEE, and an anode 61 of the organic light emitting diode OLED is connected with a gate electrode of the drive transistor Td; the first power supply signal PVEE is loaded to the gate electrode of the drive transistor Td through the organic light emitting diode OLED to reset a signal at the gate electrode of the drive transistor Td during a operating period of the pixel driving circuit; and the first power supply signal PVEE is a low-level signal.

In the second embodiment of the invention, the low-level signal of the first power supply signal PVEE is used to reset the signal at the gate electrode of the drive transistor Td to thereby eliminate the influence from a previous frame of displayed image, and the first power supply signal PVEE providing the organic light emitting diode OLED with the low-level signal is used instead of a separate reset signal.

In the second embodiment of the invention, the anode 61 of the organic light emitting diode OLED is connected with the gate electrode of the drive transistor Td through a third switch transistor T3 and a first switch transistor T1. Specifically, as illustrated in FIG. 4, the pixel driving circuit includes the first switch transistor T1, a second switch transistor T2, the third switch transistor T3, a fourth switch transistor T4, the drive transistor Td, a storage capacitor C and the organic light emitting diode OLED.

A first pole 11 of the first switch transistor T1 is connected respectively with the gate electrode of the drive transistor Td and a second pole plate 2 of the storage capacitor C, a second pole 12 of the first switch transistor T1 is connected respectively with a drain electrode D of the drive transistor Td and a first pole 31 of the third switch transistor T3, and a gate electrode of the first switch transistor T1 receives a first scan signal Scan_a.

A first pole 21 of the second switch transistor T2 is connected respectively with a second power supply signal PVDD and a first pole plate 1 of the storage capacitor C, a second pole 22 of the second switch transistor T2 is connected respectively with a source electrode S of the drive transistor Td and a second pole 42 of the fourth switch transistor T4, and a gate electrode of the second switch transistor T2 receives a first light emission signal Emit(n).

The first pole 31 of the third switch transistor T3 is connected respectively with the drain electrode D of the drive transistor Td and the second pole 12 of the first switch transistor T1, a second pole 32 of the third switch transistor T3 is connected with the anode 61 of the organic light emitting diode OLED, and a gate electrode of the third switch transistor T3 receives a second light emission signal Emit(n+1).

A first pole 41 of the fourth switch transistor T4 receives an image data signal Data, the second pole 42 of the fourth switch transistor T4 is connected respectively with the second pole 22 of the second switch transistor T2 and the source electrode S of the drive transistor Td, and a gate electrode of the fourth switch transistor T4 receives a second scan signal Scan b.

The source electrode S of the drive transistor Td is connected respectively with the second pole 22 of the second switch transistor T2 and the second pole 42 of the fourth switch transistor T4, the drain electrode D of the drive transistor Td is connected respectively with the second pole 12 of the first switch transistor T1 and the first pole 31 of the third switch transistor T3, and the gate electrode of the drive transistor Td is connected respectively with the first pole 11 of the first switch transistor T1 and the second pole plate 2 of the storage capacitor C.

The first pole plate 1 of the storage capacitor C is connected with the first pole 21 of the second switch transistor T2, the first pole plate 1 of the storage capacitor C further receives the second power supply signal PVDD, and the second pole plate 2 of the storage capacitor C is connected respectively with the first pole 11 of the first switch transistor T1 and the gate electrode of the drive transistor Td.

The anode 61 of the organic light emitting diode OLED is connected with the second pole 32 of the third switch transistor T3, and the cathode 62 of the organic light emitting diode OLED receives the first power supply signal PVEE.

In order to eliminate the influence of the previous frame of image data signal on the display of the current frame in the pixel circuit, the low-level signal of the first power supply signal PVEE is transmitted to the gate electrode of the drive transistor Td through the organic light emitting diode OLED, the third switch transistor T3 and the first switch transistor T1 to reset the signal at the gate electrode of the drive transistor Td in the pixel driving circuit according to the second embodiment of the invention.

Preferably the signal at the gate electrode of the drive transistor Td is reset before the current frame of image data signal Data is input, namely, in an initialization phase I. In the initialization phase I, the second light emission signal Emit(n+1) and the first scan signal Scan_a provide turn-on signals, and both the third switch transistor T3 and the first switch transistor T1 are turned on, so that the first power supply signal PVEE can be transmitted to the gate electrode of the drive transistor Td through the third switch transistor T3 and the first switch transistor T1 to reset the drive transistor Td.

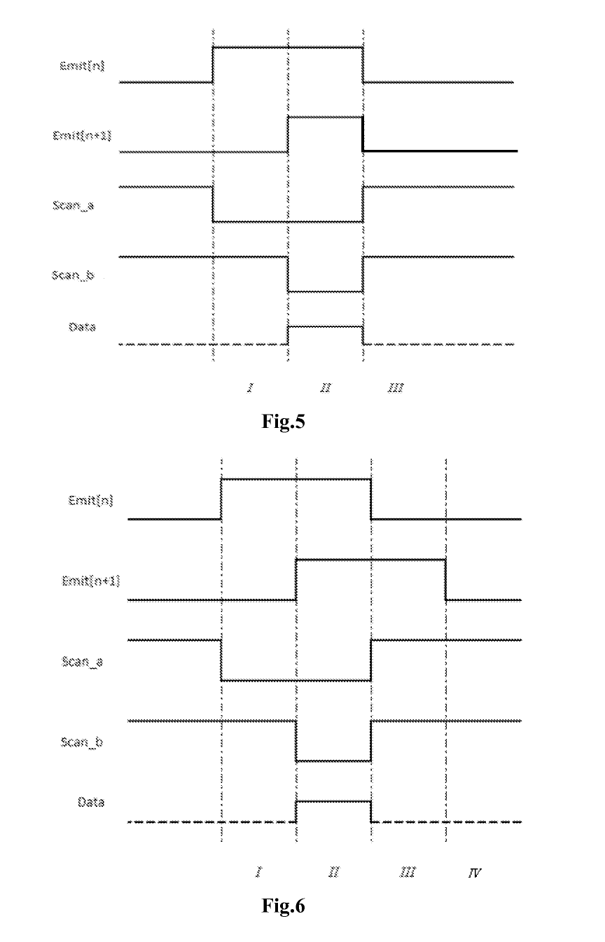

The operating period of the pixel driving circuit further includes a signal load phase II and a light emission phase III subsequent to the initialization phase I. Referring to FIG. 5, there is illustrated an operation timing diagram of the pixel driving circuit according to the second embodiment of the invention.

In the initialization phase I, the first light emission signal Emit(n) provides a turn-off signal, the second light emission signal Emit(n+1) provides a turn-on signal, the first scan signal Scan_a provides a turn-on signal, and the second scan signal Scan_b provides a turn-off signal. Since the first switch transistor T1 and the third switch transistor T3 are turned on, the first power supply signal PVEE is transmitted to the gate electrode of the drive transistor Td; since the second switch transistor T2 is turned off, the second power supply signal PVDD can not transmit a signal to the pixel driving circuit; and also since the second scan signal Scan_b provides the turn-off signal, the fourth switch transistor T4 is turned off, so that the risk of shorting the first power supply signal PVEE and the image signal Data can be lowered. In the initialization phase I, the pixel driving circuit performs the reset operation of the signal at the gate electrode of the drive transistor Td, so that the potential of the gate electrode of the drive transistor Td is the low potential of the first power supply signal PVEE.

The risk of shorting the first power supply signal PVEE and the image signal Data particularly refers to that in the current initialization phase I of the pixel driving circuit, the image signal Data does not transmit an image display signal to the pixel driving circuit, but at this time the image signal Data is transmitting an image display signal to the previous pixel driving circuit; and the first power supply signal PVEE is a stable low-level signal, so if the third switch transistor T3, the drive transistor Td and the fourth switch transistor T4 form a closed circuit in the current initialization phase I of the pixel driving circuit, then the first power supply signal PVEE may affect the signal value of the image signal Data so that the image display signal written into the previous pixel driving circuit may deviate from a normal value.

In the signal load phase II, the first light emission signal Emit(n) provides a turn-off signal, the second light emission signal Emit(n+1) provides a turn-off signal, the first scan signal Scan_a provides a turn-on signal, the second scan signal Scan_b provides a turn-on signal, and the image data signal Data transmits a display signal. The second switch transistor T2 and the third switch transistor T3 are turned off, and the first switch transistor T1 and the fourth switch transistor T4 are turned on; and the drive transistor Td is also turned on because the gate electrode of the drive transistor Td is still at the low potential of the first power supply signal PVEE when the signal load phase II just starts. The image data signal Data is transmitted to the source electrode S of the drive transistor Td through the fourth switch transistor T4, that is, the source electrode voltage Vs of the drive transistor Td is Vdata.

Also the first switch transistor T1, the fourth switch transistor T4 and the drive transistor Td are all turned on, that is, the gate electrode and the drain electrode D of the drive transistor Td are connected. The gate electrode of the drive transistor Td is charged by the image data signal Data, and when the gate electrode voltage Vg of the drive transistor Td is increased to the sum of the source electrode voltage Vs thereof and the threshold voltage Vth thereof, the drive transistor Td is turned off, and at this time the gate electrode voltage Vg of the drive transistor Td is:

Vg=Vs+Vth=Vdata+Vth (1)

At this time the voltage of the second pole plate 2 of the storage capacitor C is also (Vdata+Vth), that is, the gate electrode voltage of the drive transistor Td is stored in the second pole plate 2 of the storage capacitor C.

Next in the light emission phase III, the first light emission signal Emit(n) provides a turn-on signal, the second light emission signal Emit(n+1) provides a turn-on signal, the first scan signal Scan_a and the second scan signal Scan_b provide turn-off signals, and the image data signal Data does not transmit the display signal any more. The first switch transistor T1 is turned off, that is, the gate electrode and the drain electrode D of the drive transistor Td are disconnected, and the third switch transistor T3 is turned on, that is, the drain electrode D of the drive transistor Td is connected with the anode of the organic light emitting diode OLED, so that the organic light emitting diode OLED can be driven by the drain electrode current of the drive transistor Td to emit light. Also since the second switch transistor T2 is turned on, the source electrode voltage Vs of the drive transistor Td is the high voltage Vdd of the second power supply signal PVDD in the light emission phase III, and at this time the drain electrode current I of the drive transistor Td is:

$$I = \frac{1}{2} {k ( Vg - Vs - Vth )}^{2} = \frac{1}{2} {k ( Vdata - Vdd )}^{2} \qquad ( 2 )$$

Where K is a constant. As shown in Equation (2), the drain electrode current I of the drive transistor Td is independent of the threshold voltage Vth of the drive transistor Td, so the non-uniformity of display due to different threshold voltages of multiple drive transistors can be eliminated to thereby achieve a better display effect in the pixel driving circuit according to the second embodiment of the invention.

In the pixel driving circuit according to the second embodiment of the invention, the signal at the gate electrode of the drive transistor Td is reset by the first power supply signal PVEE prior to the signal load phase to thereby ensure the current frame of image data signal Data to be written smoothly, and also the reset signal is provided by the first power supply signal PVEE which originally provides the cathode signal to the organic light emitting diode OLED, instead of a separate reset signal, to thereby simplify the circuit structure and facilitate the miniaturization of the pixel driving circuit. Moreover the non-uniformity of display due to different threshold voltages of multiple drive transistors can be eliminated to thereby achieve the better display effect in the pixel driving circuit according to the second embodiment of the invention. Furthermore in the initialization phase I, the second scan signal Scan_b provides the turn-off signal and thus the fourth switch transistor T4 is turned off to thereby lower the risk of shorting the first power supply signal PVEE and the image signal Data and ensure the overall display effect.

Preferably, in two adjacent pixel driving circuits, the second light emission signal Emit(n+1) of the previous pixel driving circuit is the same signal as the first light emission signal Emit(n) of the next pixel driving circuit. Referring to FIG. 6, there is illustrated another operation timing diagram of the pixel driving circuit according to the second embodiment of the invention, which includes an initialization phase I, a signal load phase II, a wait phase III and a light emission phase IV in that order, where the difference from the operation timing diagram illustrated in FIG. 5 lies in that there is further the wait phase between the signal load phase and the light emission phase. In the wait phase III, the second light emission signal Emit(n+1) is maintained at the high level. In wait phase III, all of the first light emission signal Emit(n), the scan signal Scan(n) and the image data signal Data are the same as those in the light emission phase IV.

The same operation effect as the operation timing illustrated in FIG. 5 can also be achieved by using the another operation timing of the pixel driving circuit according to the second embodiment of the invention, but the second light emission signal Emit(n+1) in the previous pixel driving circuit is the same signal as the first light emission signal Emit(n) of the next pixel driving circuit to thereby dispense with one signal source electrode so as to further simplify the method of driving the pixel driving circuits.

The embodiments of the invention described above have been numbered merely for the sake of description without representing any superiority or inferiority of one embodiment to another. Evidently those skilled in the art can make various modifications and variations to the invention without departing from the spirit and scope of the invention. Thus the invention is also intended to encompass these modifications and variations thereto as long as these modifications and variations come into the scope of the claims appended to the invention and their equivalents.

What is claimed is:

1. A pixel driving circuit, comprising a drive transistor and an organic light emitting diode, wherein a cathode of the organic light emitting diode receives a first power supply signal, and an anode of the organic light emitting diode is connected with a gate electrode of the drive transistor; the first power supply signal is loaded to the gate electrode of the drive transistor through the cathode and the anode of the organic light emitting diode to reset a signal at the gate electrode of the drive transistor during an operating period of the pixel driving circuit; and the first power supply signal is a low-level signal.

2. The pixel driving circuit according to claim 1, further comprising a first switch transistor, a second switch transistor, a third switch transistor, a fourth switch transistor and a storage capacitor, wherein:
a first pole of the first switch transistor is connected respectively with the gate electrode of the drive transistor and a second pole plate of the storage capacitor, a second pole of the first switch transistor is connected respectively with a drain electrode of the drive transistor and a first pole of the third switch transistor, and a gate electrode of the first switch transistor receives a scan signal;
a first pole of the second switch transistor is connected respectively with a second power supply signal and a first pole plate of the storage capacitor, a second pole of the second switch transistor is connected respectively with a source electrode of the drive transistor and a second pole of the fourth switch transistor, and a gate electrode of the second switch transistor receives a first light emission signal;
the first pole of the third switch transistor is connected respectively with the drain electrode of the drive transistor and the second pole of the first switch transistor, a second pole of the third switch transistor is connected with the anode of the organic light emitting diode, and a gate electrode of the third switch transistor receives a second light emission signal;
a first pole of the fourth switch transistor receives an image data signal, the second pole of the fourth switch transistor is connected respectively with the second pole of the second switch transistor and the source electrode of the drive transistor, and a gate electrode of the fourth switch transistor receives the scan signal;
the source electrode of the drive transistor is connected respectively with the second pole of the second switch transistor and the second pole of the fourth switch transistor, the drain electrode of the drive transistor is connected respectively with the second pole of the first switch transistor and the first pole of the third switch transistor, and the gate electrode of the drive transistor is connected respectively with the first pole of the first switch transistor and the second pole plate of the storage capacitor;
the first pole plate of the storage capacitor is connected with the first pole of the second switch transistor, the first pole plate of the storage capacitor further receives the second power supply signal, and the second pole plate of the storage capacitor is connected respectively with the first pole of the first switch transistor and the gate electrode of the drive transistor; and
the anode of the organic light emitting diode is connected with the second pole of the third switch transistor, and the cathode of the organic light emitting diode receives the first power supply signal; and the anode of the organic light emitting diode is connected with the gate electrode of the drive transistor through the third switch transistor and the first switch transistor.

3. The pixel driving circuit according to claim 2, wherein the operating period of the pixel driving circuit comprises an initialization phase in which the third switch transistor and the first switch transistor are turned on, and the first power supply signal is loaded to the gate electrode of the drive transistor through the cathode and the anode of the organic light emitting diode, the third switch transistor and the first switch transistor to reset the signal at the gate electrode of the drive transistor.

4. The pixel driving circuit according to claim 3, wherein the operating period of the pixel driving circuit further comprises a signal load phase and a light emission phase subsequent to the initialization phase, wherein in the signal load phase, the fourth switch transistor and the first switch transistor are turned on, and the image data signal is transmitted to the gate electrode of the drive transistor; and in the light emission phase, the second switch transistor and the third switch transistor are turned on, and the organic light emitting diode is driven by a current at the drain electrode of the drive transistor to emit light for display.

5. The pixel driving circuit according to claim 4, wherein in two adjacent pixel driving circuits, a second light emission signal of a previous pixel driving circuit is a same signal as a first light emission signal of a next pixel driving circuit.

6. The pixel driving circuit according to claim 5, wherein the operating period of the pixel driving circuit further comprises a wait phase between the signal load phase and the light emission phase, and the third switch transistor is turned off in the wait phase.

7. The pixel driving circuit according to claim 1, further comprising a first switch transistor, a second switch transistor, a third switch transistor, a fourth switch transistor and a storage capacitor, wherein:
a first pole of the first switch transistor is connected respectively with the gate electrode of the drive transistor and a second pole plate of the storage capacitor, a second pole of the first switch transistor is connected respectively with a drain electrode of the drive transistor and a first pole of the third switch transistor, and a gate electrode of the first switch transistor receives a first scan signal;
a first pole of the second switch transistor is connected respectively with a second power supply signal and a first pole plate of the storage capacitor, a second pole of the second switch transistor is connected respectively with a source electrode of the drive transistor and a second pole of the fourth switch transistor, and a gate electrode of the second switch transistor receives a first light emission signal;
the first pole of the third switch transistor is connected respectively with the drain electrode of the drive transistor and the second pole of the first switch transistor, a second pole of the third switch transistor is connected with the anode of the organic light emitting diode, and a gate electrode of the third switch transistor receives a second light emission signal;
a first pole of the fourth switch transistor receives an image data signal, the second pole of the fourth switch transistor is connected respectively with the second pole of the second switch transistor and the source electrode of the drive transistor, and a gate electrode of the fourth switch transistor receives a second scan signal;
the source electrode of the drive transistor is connected respectively with the second pole of the second switch transistor and the second pole of the fourth switch transistor, the drain electrode of the drive transistor is connected respectively with the second pole of the first switch transistor and the first pole of the third switch transistor, and the gate electrode of the drive transistor is connected respectively with the first pole of the first switch transistor and the second pole plate of the storage capacitor;
the first pole plate of the storage capacitor is connected with the first pole of the second switch transistor, the first pole plate of the storage capacitor further receives the second power supply signal, and the second pole plate of the storage capacitor is connected respectively with the first pole of the first switch transistor and the gate electrode of the drive transistor; and
the anode of the organic light emitting diode is connected with the second pole of the third switch transistor, and the cathode of the organic light emitting diode receives the first power supply signal; and the anode of the organic light emitting diode is connected with the gate electrode of the drive transistor through the third switch transistor and the first switch transistor.

8. The pixel driving circuit according to claim 7, wherein in two adjacent pixel driving circuits, a second light emission signal of a previous pixel driving circuit is a same signal as a first light emission signal of a next pixel driving circuit.

9. The pixel driving circuit according to claim 7, wherein the operating period of the pixel driving circuit comprises an initialization phase in which the third switch transistor and the first switch transistor are turned on, and the first power supply signal is loaded to the gate electrode of the drive transistor through the cathode and the anode of the organic light emitting diode, the third switch transistor and the first switch transistor to reset the signal at the gate electrode of the drive transistor; and the fourth switch transistor is turned off.

10. The pixel driving circuit according to claim 9, wherein the operating period of the pixel driving circuit further comprises a signal load phase and a light emission phase subsequent to the initialization phase, wherein in the signal load phase, the fourth switch transistor and the first switch transistor are turned on, and the image data signal is transmitted to the gate electrode of the drive transistor; and in the light emission phase, the second switch transistor and the third switch transistor are turned on, and the organic light emitting diode is driven by a current at the drain electrode of the drive transistor to emit light for display.

11. The pixel driving circuit according to claim 10, wherein the operating period of the pixel driving circuit further comprises a wait phase between the signal load phase and the light emission phase, and the third switch transistor is turned off in the wait phase.

12. An organic light emitting display device, comprising the pixel driving circuit according to claim 1.

13. An organic light emitting display device, comprising the pixel driving circuit according to claim 7.

14. A system for driving a display, the system comprising:
a drive transistor, the drive transistor comprising a first gate electrode and a source electrode;
an organic light emitting diode, the organic light emitting diode comprising a cathode and an anode, the cathode being configured to receive a first power supply signal, the first power supply signal being a low-level signal, the anode being electrically coupled to the gate electrode;
a storage capacitor;
a first switch transistor electrically coupled to the storage capacitor, the first switch transistor comprising a second gate electrode for receiving a scan signal;
a second switch transistor comprising a third gate electrode for receiving a first light emission signal;
a third switch transistor electrically coupled to the anode and comprising a fourth gate electrode for receiving a second light emission signal; and
a fourth switch transistor being electrically coupled to source electrode;
wherein:
the first power supply signal is loaded to the first gate electrode through the anode and the cathode for resetting a signal at the gate electrode during an operating period.
